(19) United States
(12) Patent Application Publication
(10) Pub. No.: US 2009/0222117 A1
(43) Pub. Date: Sep. 3, 2009

(54) SYSTEM, APPARATUS, AND METHOD FOR MANAGING PRELOADED CONTENT FOR REVIEW ON A HANDHELD DIGITAL MEDIA APPARATUS

(76) Inventors: Joshua Kaplan, Berkeley, CA (US); Joseph Schlessinger, Berkeley, CA (US); Benjamin Camgros, Fairfax, CA (US); William MacKenzie, Portola, CA (US)

Correspondence Address: DERGOSITS & NOAH LLP, Three Embarcadero Center, Suite 410, SAN FRANCISCO, CA, 94111, US

(21) Appl. No.: 12/280,708

(22) PCT Filed: Mar. 1, 2007
(86) PCT No.: PCT/US07/05316

§ 371 Date: Jan. 15, 2009

Related U.S. Application Data
(63) Continuation of application No. 11/365,545, filed on Mar. 1, 2006.

(51) Int. Cl. G06F 17/00; G06Q 30/00; G06Q 50/00

(52) U.S. Cl. 700/94; 705/26; 705/10

(57) ABSTRACT

A portable digital media playback apparatus is preloaded with digital media files for preview. The files may be tagged with information to indicate the user wishes to purchase the digital media file or purchase certain digital rights associated with the digital media file. When the portable device is re-synched with a library of digital media files available for purchase, the files designated for purchase are downloaded to the portable device. In one embodiment, a user profile is created and includes a record of user events relating to the digital media files previewed, deleted or purchased. The content provider adopts a set of criteria for matches and creates a list of additional digital media files that are compatible with the user and which will be pushed down to the portable device the next time that the user synchronizes the device.

### TECHNICAL FIELD

The present invention relates generally to a system, apparatus, and method for providing preloaded content for review on a digital media apparatus. More particularly, the present invention in a preferred embodiment relates to a digital media playback apparatus having previewable digital files which are preloaded onto the digital media playback apparatus during manufacture or at the purchase location. In another preferred embodiment, a flash memory card is provided for use with a smart phone to provide a web browser application for displaying web-page-content that has been pre-filtered and pre-formatted for presentation on the smart phone display screen.

### BACKGROUND OF THE INVENTION

Portable digital media players have gained significant popularity. For example, the Apple iPod™ is a portable music player that has changed the way most people view music playback. The portable digital media players typically have large amounts of storage capacity (e.g., 512 kilobits to 60 gigabits). However, it is believed that over 50% of that capacity is not used because of various factors. For example, users may not have time to load all of their own music, or the method of converting normal content to compressed digital files (e.g., mp3, mpeg, avi, etc.) may be viewed as too cumbersome or time-consuming.

Furthermore, the digital media (e.g., music, video, or text) is typically placed onto the portable digital media players using a computer by either (i) converting media (e.g., compact discs (“CDs”) or digital video discs (“DVDs”)) to the appropriate compressed digital file or (ii) purchasing a compressed digital file from an online provider, e.g., the iTunes TM web site. In order to purchase a digital file from an online provider, the user typically reviews various digital media on the web site of the online content provider, and then purchases the digital media for download onto the computer. The digital media then has to be transferred to the portable digital media player by using software on the computer that is compatible with the portable player. This can be a cumbersome and time-consuming process.

In addition, due to stringent Digital Rights Management requirements, the content copyright owners require that the end user possess all of the rights before the user downloads the digital media files onto any device.

Accordingly, there is a need to more efficiently utilize the free space available on portable digital media players. There is also a need to provide a more streamlined process for reviewing and purchasing digital media files. There is also a need for a platform for digital content providers to deliver personalized content to the end user, based upon user behavior and selections.

Smart phones with high capacity Secure Digital storage cards (flash memory) and with highly functional operating systems are becoming more popular. When these smart phones are used to establish communications sessions on the Internet, the result can be agonizing to the user because the speed of the Internet connection is slow, the Internet web page content has not been aptly formatted for the limited-screen-size format of the smart phone, and the efforts to replicate the experience. of a computer-based web browsing on the smart phone have not been successful. Consequently, smart-phone-based web browsing applications are desired to take advantage of the technological capabilities of the smart phone with high capacity secure digital cards and highly functional smart phone operating systems, while providing an enjoyable user browsing experience.

### SUMMARY OF THE INVENTION

One object of the invention is to efficiently utilize the free space available on portable digital media players by preloading the device with digital media files for preview at the time of manufacture or purchase of the device. Another object of the invention is to provide a streamlined process for previewing and purchasing digital media files.

It is believed that the apparatus, system and method of the present invention allow the following benefits. Preloading the playback apparatus effectively utilizes empty space on the storage medium of the digital playback device. Furthermore, preloading the playback apparatus allows the user to be exposed to new content directly from the playback apparatus, thereby removing the requirement of going online and spending time clicking on and downloading previews to the user's computer via the Internet. Further, when the digital playback apparatus is portable, users are free to utilize the large amount of free time available away from home to preview the digital media files in their own privacy, as the devices have personal headphones as opposed to loudspeakers.

One aspect of the present invention is to have huge amounts of digital products preloaded on various devices (books, movies, software, music) and allow people to preview, rate the items, indicate a ‘purchase’ or ‘delete’ response located on the device, and then, when the user re-synchs, items purchased are then fully downloaded, or licensed according to the digital rights (including rental) while items reviewed and rated negatively are deleted from the device.

According to one embodiment of the present invention, a portable digital media playback apparatus is provided having a large number of preloaded digital media files for preview by a user. The playback apparatus has an operating system for operating the portable digital media playback apparatus with executable software code for (1) tagging at least one preloaded digital media file with information that identifies that file as a file for purchase or rental by the user; (2) communicating the information concerning the tagged file to a computer separate from the portable digital media playback apparatus; and, (3) deleting digital media files from the portable digital media playback apparatus when a delete command is received from the separate computer for a particular digital media file. The playback apparatus also has a communication port allowing the portable digital media playback apparatus to communicate with the separate computer. The playback apparatus further includes a data storage device preloaded during manufacture of the playback apparatus, or at the time of purchase, with at least about 128 KB of digital media files for preview by the user, the digital media files optionally having limited usage rights. The playback apparatus has a user interface associated with the portable digital media playback apparatus operating system to direct the operating system to tag one or more digital media files with information that identifies that file as a file for purchase or rental by the user. The playback apparatus can be optionally preloaded with digital media files for preview at a level of between about 25% and 100% of the playback apparatus data storage.

One of the methods of the present invention is a method for providing and managing large numbers of digital media files on a portable digital media playback apparatus for preview and purchase or rental by a user, for use in conjunction with a computer separate from the portable digital media playback apparatus. The method involves (1) providing a portable digital media playback apparatus having an operating system including executable code (a) for tagging at least one of the digital media files with information that identifies that file as a file for purchase or rental; (b) communicating information concerning the tagged file to the computer separate from the portable digital media playback apparatus; and (c) for deleting digital media files from the portable digital media player apparatus when a delete command is received from the separate computer directed to a particular digital media file. The playback device also has a communication port allowing the portable digital media playback apparatus to communicate with the separate computer, and, a data storage device. According to the method, another step is (2) providing on the portable digital media player apparatus storage device at the time of purchase at least about 128 KB of digital media files for preview by the user, the optional files having limited usage rights. The device also is provided with a user interface associated with the portable digital media playback apparatus operating system to tag one or more digital media files with information that identifies that file as a file for purchase or rental by the user. In response to the information that identifies that file as a file for purchase or rental, the method provides on the portable digital media playback device a digital media file that possesses the appropriate digital rights corresponding to the tagged file information. As an optional part of this method, the user is able to rate the preloaded digital media files, possibly using a rating system of 1 as the worst and 5 as the best. This rating information can be captured as part of the user profile and be used as part of the data available to the content provider to make recommendations to the user of additional digital media files for preview.

In another embodiment of the present invention, a portable digital media playback apparatus could be preloaded with a large number of digital media files at the time of manufacture or purchase. The device has (1) storage media for storing preloaded digital media files for preview by a user; (2) a large number of preloaded digital media files stored in said storage media and available for preview by the user; (3) first executable software code for deleting at least one preloaded digital media file from the portable digital media playback apparatus storage media when a delete command is received; (4) second executable software code for tagging at least one preloaded digital media file with information that identifies the file as a file for purchase or rental by the user; (5) a first user interface allowing the user to issue delete commands to the first executable software code to delete preloaded digital media files from the storage media; (6) a second user interface allowing the user, through operation of the second executable software code, to tag at least one preloaded digital media file with information that identifies that file as a file for purchase or rental by the user; (7) a communications port between the portable digital media playback apparatus and the separate computer; and, (8) third executable software code for allowing the portable digital media playback apparatus to issue a request to the separate computer for the appropriate digital rights for the at least one digital media file corresponding to the information that identified the file as a file for purchase or rental.

In another embodiment of the present invention, in a system comprising a portable digital media playback apparatus loaded with a large number of digital media files for preview by a user of the portable digital media playback apparatus, a separate computer and a content provider server, there is a method for delivering recommended digital media files for preview on the portable digital media playback apparatus. The method comprises the following steps: (1) on the portable digital media playback apparatus, creating a user profile based upon user interactions with the digital media files for preview loaded on the portable digital media playback apparatus; (2) transmitting the user profile from the portable digital media playback apparatus to the separate computer through a communications port on the portable digital media playback apparatus; (3) transmitting the user profile from the separate computer to the content provider server; (4) at said content-provider server, comparing characteristics of digital media files available for preview with the user profile; (5) transmitting from the content provider server to the separate computer a plurality of digital media files, optionally with limited usage rights, for preview that match at least one aspect of the user profile; and, (6) transmitting from the separate computer the plurality of digital media files, optionally with limited usage rights, for preview that match at least one aspect of the user profile to the portable digital media playback apparatus.

In connection with this embodiment, the user profile may also contain demographic information about the user, or rating information entered by the user comprising the user's rating of the digital media files that the user has already previewed, for example scoring a one (1) for the worst file and a five (5) for the best file.

It is also considered within the scope of this invention to create the user profile on the separate computer, or on the content server computer when the portable device is synched with the separate computer. This user profile captures user activities and then enables the recommendation of additional digital media files for preview.

It is also considered within the scope of the present invention to configure a system without the separate computer. In this instance, the portable playback apparatus would have to possess the ability to connect directly to the Internet using Internet browsing software.

In another embodiment, a handheld device accesses a flash memory card upon which a web browser application and pre-filtered and pre-formatted web pages have been stored. The web browser application works in conjunction with the operating system of the handheld devise to provide the capability to display the pre-stored web pages on the display screen of the handheld device. The web pages have been pre-filtered and pre-formatted for optimal display on the handheld device. The user registers with the service upon the first start up. The user provides personal information and personal preferences during the registration procedure. The user also selects the web pages she wants to view on the handheld device. When the user accesses the service, the registration information is uploaded to the service's proxy server. As part of the registration process, the user also specifies the frequency at which the web pages on the flash memory card are to be updated or refreshed.

During off-line use, the user is able to use the pre-stored web browser application to browse the web page content stored on the flash memory card. In this mode, the web pages are displayed instantaneously on the handheld device display screen.

On the service side, the system employs a poller-filter server that accesses sources of web pages. When pulled down to the poller-filter server, the original web page content is filtered and formatted for display on the handheld devices supported by the service. The pre-filtered, pre-formatted content is then stored in cache that is accessed by the system's proxy server. When the user makes a request for a web page or when the handheld device is requesting updated content, the proxy server accesses the cache, and delivers the pre-filtered, pre-formatted content to the handheld device through an Internet ISP connection between the proxy server and the handheld device.

The system can also utilize synchronization features that enable the user to synchronize the content on the handheld device with a desktop or laptop computer (a host computer). In this mode, the web browser application on the handheld device synchronizes web page data stored on the flash memory card with the web page data stored on the host computer.

### BRIEF DESCRIPTION OF THE FIGURES

FIG. 1 is a block diagram of one of the embodiments of the present invention showing the internal communications functions of a portable digital media playback device.

FIG. 2 is a block diagram showing the interface between components within the portable digital media playback device.

FIG. 3 is a block diagram showing the interface between components with an alternatively configured portable digital media playback device.

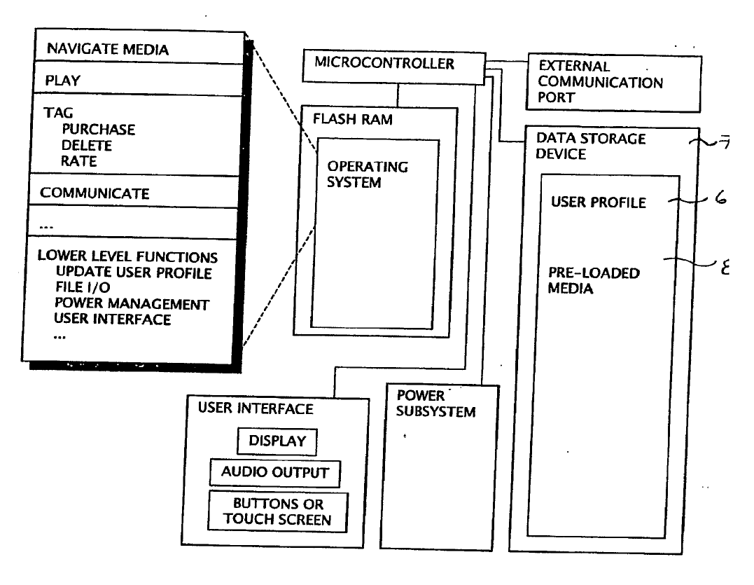

FIG. 4 is a diagram illustrating the structure and encoding of user profile information.

FIG. 5 is a system interface diagram in which the user profile information is stored on a computer separate from the portable digital media playback device.

FIG. 6 is a system interface diagram in which the user profile information is stored on the content server.

FIG. 7 is a block diagram showing the preloaded content files stored on the portable digital media playback device.

FIG. 8 is a flow diagram showing a sequence of events relating to the browsing of the preloaded digital media.

FIG. 9 is a flow diagram for events relating to the media recommendation engine, driven by the user profile data, which, in this embodiment, is stored on a separate or host computer.

FIG. 10 is a flow diagram for events relating to the media recommendation engine, driven by the user profile data, which, in this embodiment, is stored on the content server.

FIG. 11 is a flow diagram for events relating to the pre-loading of digital media at the point of sale or point of manufacture, based upon user stated preferences.

FIG. 12 is a block diagram showing the components of another embodiment directed to smartphones with removable secure flash memory cards.

FIG. 13 is a block diagram showing the filter-format functions of the poller and filter server of another embodiment of the present invention.

### DETAILED DESCRIPTION OF THE INVENTION

### Preloaded Digital Content With Portable, Handheld Playback Device

The term “portable digital media playback apparatus,” as used herein, means any handheld apparatus that provides playback of digital files. Nonlimiting examples include handheld music players (e.g., the iPod Nano, and other products in the iPod product line as well as the Zen Player), handheld video players (e.g., the iPod), cell phones, personal digital assistants (“PDA”), and any other flash memory based or portable hard drive based handheld devices (such as those currently marketed by SanDisk) having digital media playback capabilities.

The term “digital media,” as used herein, means electronically-represented data that provides content in audio or visual or audio and visual forms. Nonlimiting examples of digital media include text (e.g., books), graphics, photographs, still frames from video, schematics, maps, music, voice recordings, spoken word, and movies or video-based content. The “digital media” can be presented as a web page or as apary of a web page.

The term “digital media management software,” as used herein, means a computer executable program that manages digital media files. The media management software can be resident on a personal computer (e.g., iTunes), wherein a portable digital playback apparatus (e.g., iPod), defined below, can communicate with the management software for downloading digital media files to the portable digital playback apparatus. Alternatively, the media management software can be resident on the portable digital playback apparatus (e.g., a cell phone or PDA). Example of digital media management software are Apple's iTunes 6.0, Rhapsody, Napster, Real Player and other commercially available software for the loading, deleting, storage, organization and playback of digital media files.

The term “digital rights management system,” as used herein, means a system that keeps track of the usage rights of a digital media file. Digital Rights Management is the umbrella term referring to any of several technologies to enforce pre-defined policies controlling access to software, music, movies or other digital data. In more technical terms, DRM handles the description, layering, analysis, valuation, trading and monitoring of the rights held over a digital work. See http://en.wikipedia.org/wiki/Digital-rights-management, the disclosure of which is incorporated by reference. See also, Windows Media Digital Rights Management (DRM), a platform to protect content for playback on computers, portable devices, and network devices. See

http://www.microsoft.com/windows/windowsmedia/drm/default.mspx. See also http://www.activeinternet.com/drm/?GoogleDRM. For example, the digital rights management system can include hardware and/or software to delete digital media files from data storage according to the usage rights (e.g., after 14 days, or 3 previews). The digital rights management system can be a separate system, a part of the operating systems of the portable digital media playback apparatus, a part of the operating system of a computer executing the media management software for the portable apparatus, a part of the media management software on the computer or on the portable apparatus, or combinations thereof. It can also exist and be executed on the content-provider server.

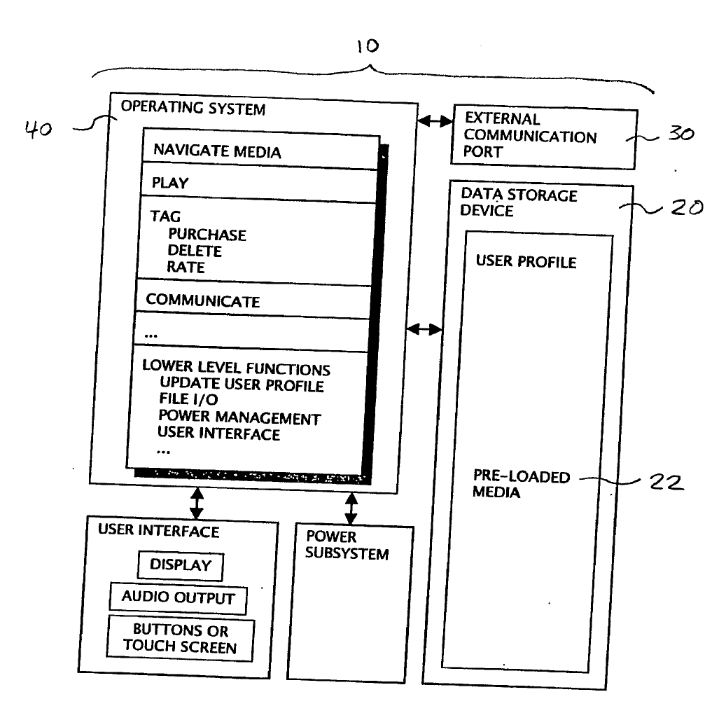

According to one preferred embodiment of the present invention, there is a portable digital media playback apparatus 10 shown in FIG. 1. The playback apparatus 10 has a massive storage device 20 which may be flash memory or a miniature hard drive, or some other space-efficient massive storage device capable of storing at least about 1 Gegabyte of data. The playback apparatus 10 has an external communications port 30 which allows the playback device to communicate with external devices such as other computers or other portable devices. The communications port can effect these communications with external devices through hard-wired connections such as USB, Firewire, telephone cable, cable television line, and Ethernet cable. The communications port can also use wireless technology such as Bluetooth, 802.11g or infrared technology. The massive storage device 20 is in communication with a processor on the playback device 10 that is instructed by a portable device operating system 40. The operating system 40 can be, e.g., Apple's iPod portable music player proprietary operating system, or something similar. When the first iPod was released in 2001, its software's “About” section listed PortalPlayer, a company that offers platform suites for computer and consumer electronics manufacturers developing portable digital entertainment devices. A small company called Pixo was also credited. whose focus was on developing a wireless software platform and services for phone manufacturers. The Pixo software platform (Pixo Platform) included the Pixo Platform Applications, Pixo User Interface Builder, Pixo Application Framework, Pixo Toolbox, Pixo Kernel, Pixo Partner Applications, Pixo Internet Microbrowser, and so on.

The iPod uses PortalPlayer's “Digital Media Platform”, which is marketed as a turn-key solution as it includes System-On-Chip integrated circuits (ICs), a customizable firmware suite, integrated third party services, PC software, and so on. The iPod uses PortalPlayer's PP50xx chip, which contains two ARM7TDMI microprocessor cores. The iPod's embedded operating system, including its encoding and decoding components, also come from PortalPlayer.

Pixo's software, particularly the Toolbox, provided the foundation on which the iPod's user-interface was designed and implemented by Apple. The Pixo Toolbox included modules for memory management, low-level graphics such as bitmaps, boxes, lines, and text, Unicode, collection classes, resource database, and standard libraries. Pixo provided a range of data applications too, such as Address Book, Calculator, Calendar, Email, Graphical World Clock, Memo Maker, Todo List, and PC Synchronization.

Other examples of portable playback apparatus operating systems are the operating systems found in, e.g., Palm handheld PDAs, Treo and Blackberry hand sets for telephony including e-mail. Smartphones equipped with high capacity Secure Digital storage cards also have operating systems that can be accessed by the present invention

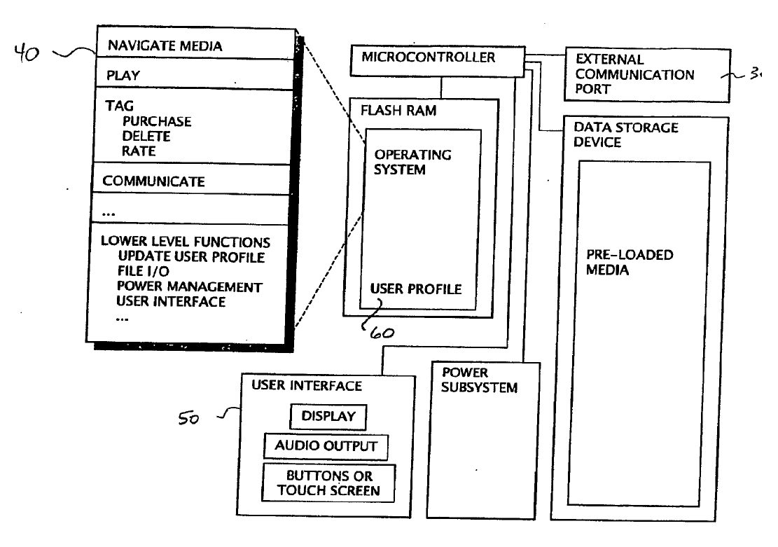

According to this embodiment of the present invention, referring now to FIG. 2, the operating system 40 should be able to manage data storage functions, including the ability to place files into storage, recall files from storage and delete files from storage, as well as to manage the power functions of the portable device 10. In addition, the operating system should also facilitate communications to and from the external communications port 30. The operating system 40 also should include instruction sets that enable it to create a user interface 50 such as, for example, the one shown in FIG. 2. In this embodiment, this user interface is graphical in nature and would be shown on a display screen of some kind familiar to those of ordinary skill in the art. The user would be able to navigate the operating system through the user interfaces shown on the display and in some circumstances with actual input devices such as buttons or keys. Typical tasks shown on the user interface, e.g., display screen, would be to select a digital media file from the library, to indicate through a tag or check or highlight, the user's interest in purchasing or renting the chosen file; or an instruction to delete one or more digital media files on the portable playback apparatus. The user interface may also provide the ability for the user to rate a digital media file that she has previewed. The user interface may use, for example, a scale of one (1) as the worst to five (5) as the best. These examples are intended to be illustrative and not limiting as to the configuration and operation of the user interface. It is also possible that the user interface could be voice-driven through commonly available speech synthesis and recognition software, rather than be a graphical user interface. It is also possible that the user interface could also be a combination of graphical presentations and voice-driven.

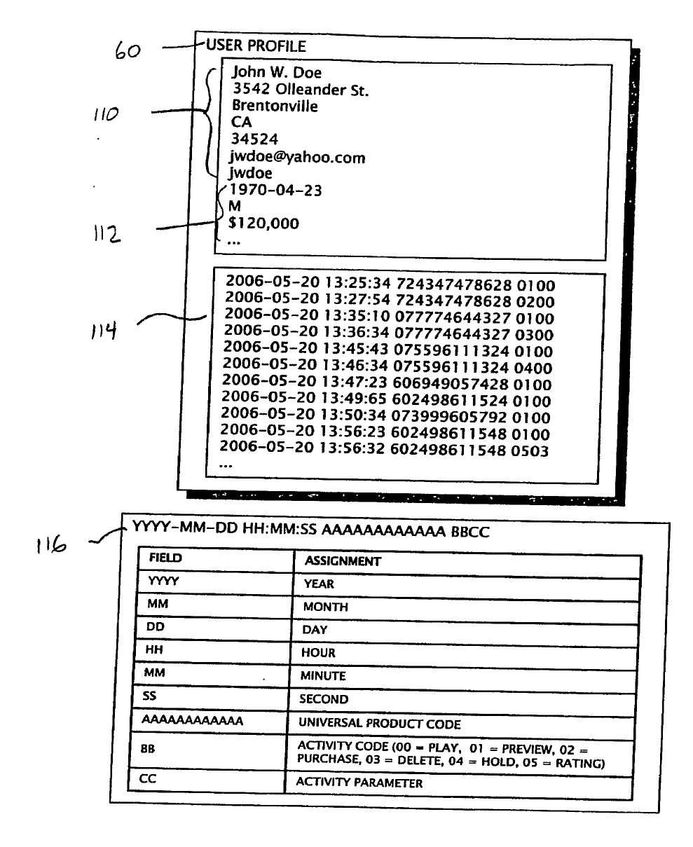

In this embodiment, also present on the portable playback apparatus 10 is a user profile 60. It can be stored in flash ram as shown in FIG. 2, or it can be stored in the larger capacity data storage device 70 along with the preloaded media files 80. Referring now to FIG. 4, in one embodiment, the user profile 60 contains data related to the user's selections of digital media files to preview, to purchase, to delete or to hold for additional usage. These activities are given codes that relate a particular activity to a digital media file present on the device. The user profile 60 may also contain personal information 110 or demographic information 112 about the user such as e-mail address, name, user name, age, income, sex and the like. The user profile 60 may also contain information 114 about ratings assigned to the various digital media files by the user in response to a preview event. See FIG. 4.

The structure and content of one embodiment of the user rating data 114 is shown in FIG. 4. According to this embodiment, the device maintains data concerning particular activities involving certain files, such as, e.g., play, preview, purchase, delete, hold or rate. The log entries are structured as shown in the encoding/decoding table 16 at the bottom of FIG. 4.

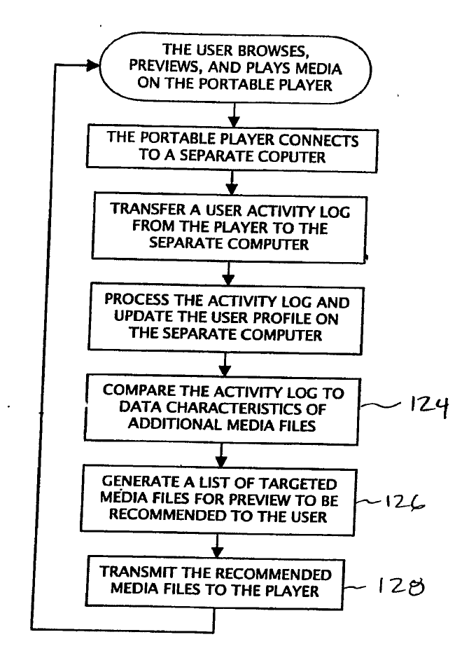

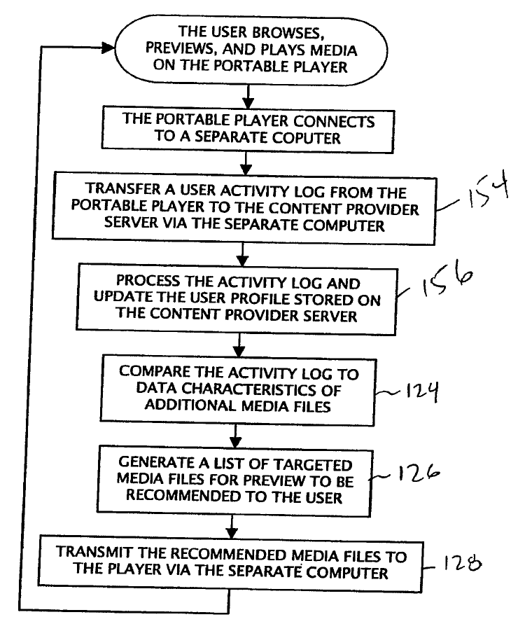

As discussed more filly below, and shown in FIG. 9 and FIG. 10, the user profile may be used by a content provider to recommend digital media files to be loaded on the portable playback apparatus by comparing the user profile with characteristic data about additional digital files that the content provider wants to push down to the user to entice sales 124. If there is a minimum set of matches, then the content provider will direct recommendations to the user of additional digital media file for preview. Blocks 126 and 128.

There are many commercial customer relations management software products available to use to capture user activity on the portable playback device and to match this activity against digital media available for sale and rental to provide recommendations for additional digital media products to preview. Among some of the most widely used programs and services are Kana Software (Menlo Park, Calif. 94025), www.kana.com; Coremetrics, Inc. (San Mateo, Calif. 94404), www.coremetrics.com; and Mercado Software (Pleasanton, Calif. 94588), www.mercado.com. Some additional programs/services for performing the functions associated with the collection of data into a user profile and the use of that data for purposes of making user-specific recommendations are available at www.clicktracks.com; www.opentracker.net; and, www.mediaplex.com. Applicant also hereby incorporates by reference those portions of U.S. Pat. No. 5,963,916 that relate to the tracking of user activities on the content provider web site and storing records of those activities in association with the user identification.

In addition, the user profile data from one user can be aggregated by the content provider to compile marketing data for sale to digital media market participants. The provision of this aggregate market research data helps to generate additional revenues from operation of the portable device and/or related Internet sites.

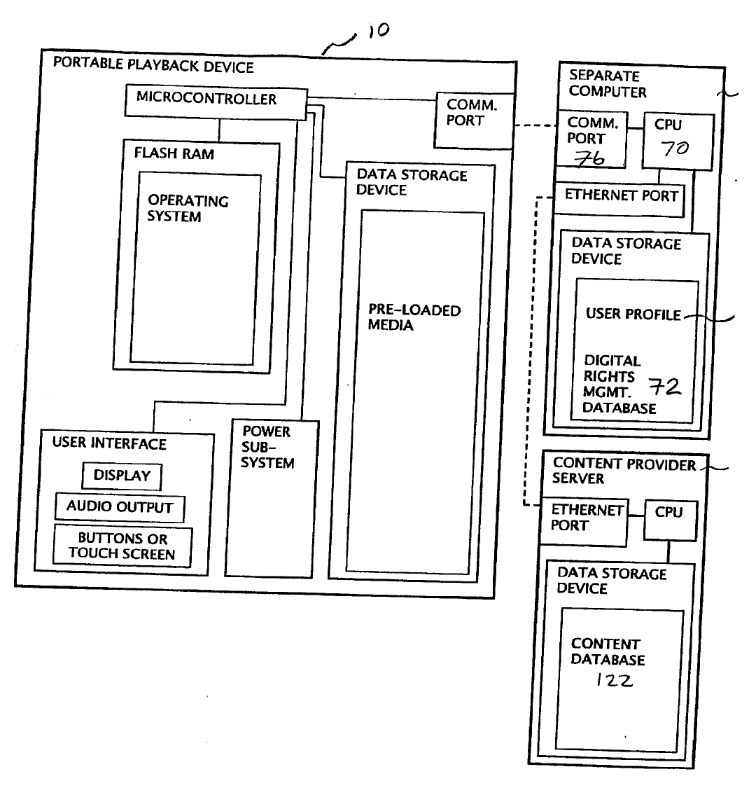

In an alternative embodiment, as shown in FIG. 5, the user profile is not kept on the playback device 10. Instead, the aggregate of the user's activities are transferred from the playback device 10 to a separate computer 118 where some determination is made of the user's actions to be captured into a user's profile 60. This user's profile 60 data is then compared with data characteristic of additional digital media files available for preview. Using parameters determined by the content provider or his agent, the user profile 60 is used to create a list of digital media files for preview to be recommended to the user. This list then gets passed from the separate computer 118 to the portable playback apparatus 10 in the form of additional digital media files for preview, optionally with restricted digital rights that would provide for deletion after a particular amount of time or number of preview events.

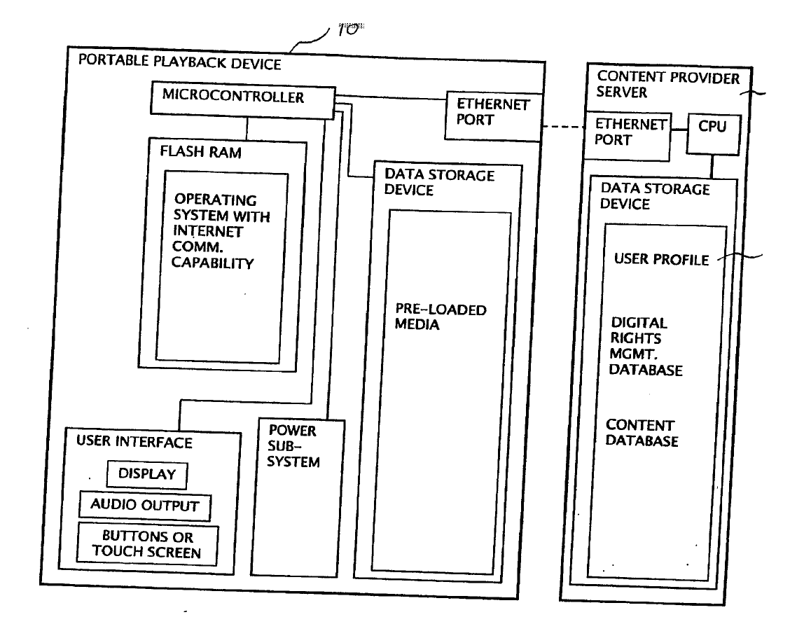

In another embodiment shown in FIG. 6, the user profile 60 is created at the content provider server 120 by extracting information from the user interactions such as, for example, purchase, delete, hold commands, user's ratings of the digital media file, and/or personal information such as e-mail address, sex, income, musical preference, etc. (See e.g., structure and codes in FIG. 4.) In much the same way as user profiles 60 created on the portable device 10, or created on the separate computer 118, are used to recommend additional digital media available for sale or rental, the user profile 60 created at the content provider server 120 is used in the same way.

Because some current portable (i.e. handheld) playback devices are not fully enabled with robust operating systems, another component of the system may be the separate computer 118 that has a CPU 70, digital rights management database 72, a user profile database 60 and communications port 76 that can communicate with the portable playback apparatus 10 and to a content server 120 with digital files database 122. This server device, and possibly separate data storage, may be connected to the separate computer 118 through the Internet, but it may also be some sort of other network link, such as for example LAN/Ethernet. In the preferred embodiment, the separate computer 118 is designed to operate as a portal or go-between the portable device 10 and the content provider 120. The separate computer 118 can be the user's personal computer running digital media management software, optionally including a digital rights management system 72. In the preferred embodiment, the separate computer would operate in substantially the same way as does the personal computer in the current use of iTunes and/or the iPod. In other words, the music library or video library is maintained and managed on the separate personal computer 118 and then the portable device 10 is “synched” or synchronized with the state of the digital media files on the personal computer 118.

The separate computer 118 may also be an in-store device provided as a retail outlet for content to be loaded on the portable device. In essence, it is a “digital filling station” or an ATM machine for music The user can attach the portable device 10 to the retail computer 118 to upload selections, download purchases or rentals and to receive additional digital media files for preview.

It is also part of the present invention that the separate computer 118 can be eliminated as part of the system as shown in FIG. 6. So, for example, if the portable device 10 has Internet browsing capability, then digital media files can be uploaded or downloaded to a content provider server 120, thereby eliminating the need for the intermediate computer. In order for this configuration to be effective, the portable device 10 should include at a minimum, digital media management software and Internet browsing software.

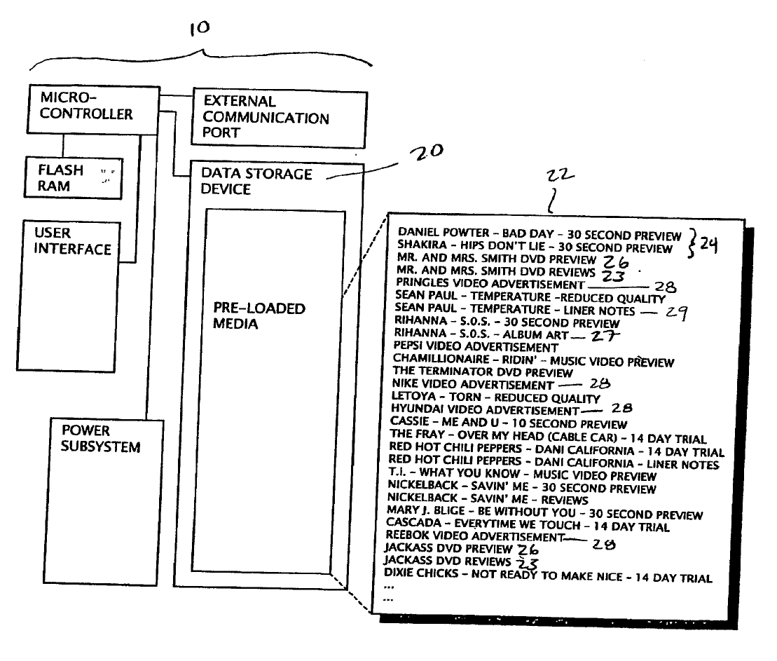

According to the preferred embodiment shown in FIGS. 1 and 7, the portable digital media playback apparatus 10 is preloaded with digital media files 22 for preview by the user. The preloading can be done as part of the manufacturing process. It can also be done by a reseller who wants to provide a device full of digital media files 22 for preview when the user buys the playback device 10. It can also be done at the point of sale of the playback device. The purpose of preloading digital media files 22 is to utilize the massive storage 20 present on the playback device 10 as away in which to drive sales of digital media products.

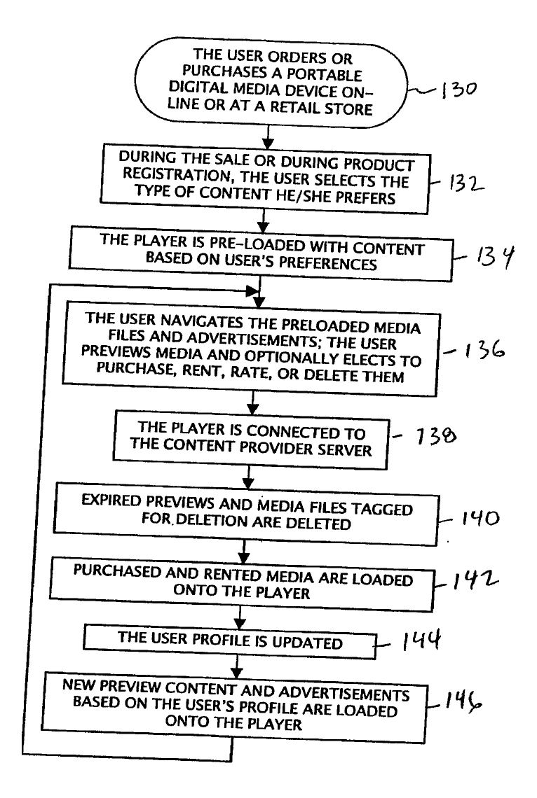

In one embodiment of the invention as shown in FIG. 7 and FIG. 11, the user/purchaser can specify particular types of digital media files 22 to be loaded on to the portable device 10 prior to, or at the time of purchase 130, 132. For example, a user may order a portable device online and specify that it be preloaded with digital media files 22 for preview comprising, e.g., rock and pop music 24, or he may specify DVD preview files in the “Action” genre 26. In addition to online or telephone pre-ordering, the user and reseller may provide for the preloading to occur at a retail or public location where the portable device 10 can be hooked up to the content server 120 and rapidly loaded with large number of digital media files 22 for preview 134. In addition, the device 10 may be rapidly loaded with content 22 from files stored on SD drives that may be inserted into the portable playback device, through the communications port 30, or some other slot or physical connectivity.

In addition to the digital media files for preview, the portable device may also be loaded with other content related to digital media such as CD/album cover art 27, liner notes 29, reviews 23 and other materials descriptive of the products. It is also expected that the content providers and/or resellers will want to also include advertisements 28 in the data downloaded to the portable device 10. It is possible that advertisers will team up with content providers so that the user obtains some type of premium (a free digital media file) in return for allowing the advertiser to download her advertisement 28 to the user's portable device 10. It is also within the scope of this invention that the advertiser will be able to have access to the user profile 60 so that contextual advertising may be pushed down to the user based upon the user's activities on the portable device 10 in interacting with the preloaded files 22.

When preloaded, the digital media files for preview can be the complete digital file available for sale with limited usage rights (for example, 14 days from loading the file will be deleted, or after 5 playbacks of the file, the file will be deleted.) The digital media file available for preview may also be a reduced quality version of the digital file available for purchase or rental, optionally with limited usage rights. Moreover, the preloaded digital media files may be a temporal portion of the entire product available for sale or purchase. So, e.g., it would be possible to preload the device with a large number of digital media files (e.g. 128 Kb) that were 30 second portions of, e.g., audio songs. The purpose of this scheme of preloading the device is to provide the user with a large number of digital media files to preview as a prelude to purchase or rental of the digital media.

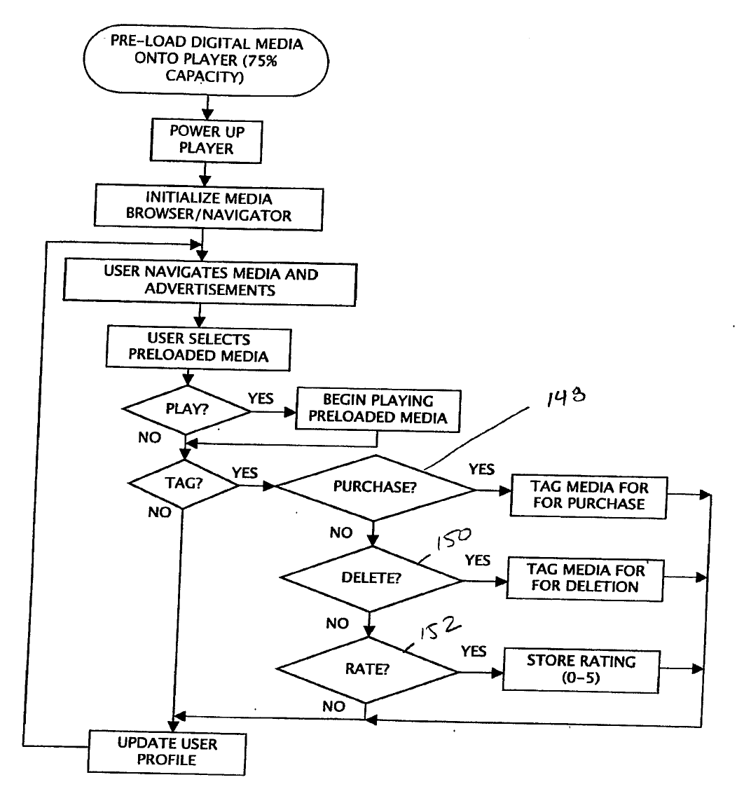

The concept here is to provide large numbers of digital media files preloaded on devices so that users can preview the items, rate them, indicate a purchase or rental selection and delete those that the user wants to delete. (FIG. 11, steps 130-146.) As shown in FIG. 8, these user activities are performed using the user interface on the portable device 10. (See FIG. 8, purchase 148, delete 150 and rate 152.) When the portable device 10 is subsequently synchronized with the media library on the separate computer 118, as in FIG. 5, the user's selections, deletions etc. are uploaded to the separate computer by the playback apparatus operating system and communications port, and then the digital media files tagged by the user of the portable device to be purchased or rented are obtained either from the content server 120, or the CPU 70 in host computer 118 which has previously obtained the digital media file from the content server 120. See boxes 124, 126, 128 in FIG. 9. The files that the user has marked for deletion are also deleted from the portable device. In certain embodiments, other digital media files are deleted from the portable device because the associated digital rights have expired. So, for example, the device may be preloaded with digital media files whose digital rights have been set so that after five (5) previews, the digital rights expire and the user no longer has the ability to play back the digital media. In order to enable this capability, there are at least two alternative configurations. In the first, the operating system on the portable device has sufficient digital media management software and digital rights management systems on the portable device to allow for the deletion of digital media files on the portable device upon expiration or fulfillment of the digital rights, conditions imposed at the time of preloading or loading. Alternatively, these functions can be performed by the separate computer. When the portable device is synchronized with the separate computer, the separate computer digital media management software and digital rights management systems can effectuate the appropriate file deletions on the portable device.

Another option that the user may be provided is to extend the digital rights on the portable device so that the user may preview the preloaded digital media file at some future point. Digital rights management software may be present on the separate computer 118 and CPU 70 and the content server 120, or both. There is some aspect of digital rights management software on the portable device that keeps track of either the time that a file has been on the device or the number of times it has been played. Examples of digital rights management systems that are capable of performing the functions just described can be found in, e.g., Apple's iTunes 6.0 and earlier versions. Other examples include U.S. patent application Ser. No. 10/703,149, published as Pub. No. 2005/0038753; U.S. patent application Ser. No. 09/773,716, published as Pub. No. 2002/0104019 Al; U.S. patent application Ser. No. 10/300,198, published as Pub. No. 2004/0098341; and, U.S. patent application Ser. No. 09/895,900, published as Pub. No. 2002/0002541. The disclosures of these publications are incorporated by reference, as is the product documentation for iTunes software.

It is also recognized that the user of the portable playback apparatus may seek and obtain digital media files from a variety of sources and possibly in a variety of file formats. It is desirable that the portable playback apparatus operating system be provided with the ability to import digital media files from a variety of sources and in a variety of formats, and still be able to “synch-up” with a single separate computer and where appropriate a single content provider. However, this is not a requirement of the invention.

FIG. 10 describes a method of recommending additional digital media files for preview based upon user activities on the portable device 10. A user profile is created on the portable device that tracks the user's interactions with the digital media files on the portable device. The user profile is transmitted (block 154) to the separate computer for subsequent transmission to the content provider server. See block 156. The content server then compares the user profile with additional files for pushing down to the user 124. The content provider sets appropriate criteria to select files for recommendation based upon common marketing principles and e.g., the available customer relations management software described above. Ultimately, the recommended digital media files are pushed down to the user. See block 128.

Handheld Device with Removable Flash Memory Card

In another embodiment of the preferred invention, the handheld device is provided with a removable flash memory card. The flash memory cards in question are presently Secure Digital cards in the Full-SD, Mini-SD, or Micro-SD form factor. Other memory protocol cards will serve equally well; at present SD is the standard that cell phone manufacturers seem to prefer. To be useful, they each need to contain upwards of 256M of data storage. The flash memory card comes preloaded with computer executable instructions that access the operating system of the handheld device and access a proxy server which is specially configured to deliver to the handheld device digital content that has been specifically formatted or filtered from its original state to optimize the display of content on the handheld device. Filtering also reduces the size of the data payload that must be delivered over the air (“OTA”); connection speed and connection costs to mobile devices are scarce resources. The flash memory card also is preloaded with digital content normally delivered through Internet accessible web pages and other sources (eg music from music repositories). When the consumer loads the flash memory card into the handheld device, and starts up the handheld device, the consumer is presented with an interface that allows the consumer to access the preloaded content on the flash memory. There is also a registration process that establishes a user profile and preferences for use in selecting and transmitting content and advertising to the handheld device. The preloaded computer executable instructions stored on the flash memory card then interact with the handheld device operating system to present content on the display of the handheld device. The preloaded computer executable instructions and the prestored content allow for the display of the content on the device display in a format compatible with the handheld device and with response speed unavailable from ordinary Internet browsing.

For clarity, the following definitions are used in describing this embodiment of the invention. These definitions are not necessarily used in the description or claims relating to other embodiments of the claimed invention. When the term appears in all upper case letters below, the term is being used in the specific sense contemplated by this glossary. In other instances when the term is not used in all upper case letters, the definition provided in the glossary is intended to be helpful but not specifically limiting.
a. CONTENT TYPES: term. Text, pictures, movies, audio.
b. CURRENT CONTENT SYSTEM: element. Consists of two main pieces: User possessed content and system-possessed content. User possessed content is a list of items and timestamps which the users has loaded on the related device. System possessed content is a list generated dynamically on the server which lists all available content.
c. FILTER ALGORITHM: function. The element that actively uses keychains and all keychain elements to decode and store sources' content in the iSource format. Triggered by the poller frequency element.
d. FILTER MACHINE: element. Refers to all elements involved with decoding and storing sources' content.
e. FORMAT CONVOLUTION: term. Directly related to key sections. Refers to the amount of unwanted content in an item and the number of locations valid content is stored at in the item. The more content types there are in an item and the more scattered valid content is on the item, the more convoluted the item becomes. The more convoluted an item is, the more key sections are needed.
f. FORMAT(S): term. Refers to how content is arranged in an item. Each source may user multiple formats for displaying its content.
g. DECODE: term. The act of pulling valid content out of a convoluted source item.
h. DELIVERY SYSTEM: function. Refers to the element that receives and fulfills requests from a device.
i. DEVICE: Mobile device, PC Application or website.
j. iSOURCE(S): element. An item which has been reformatted to be used in the iBrowz system.
k. KEYS: element. Holds decoding information about the different formats of a particular sources' item. Each key is made up of key sections.
l. KEY SECTIONS: element. Breaks the external item into pieces and content types. Also, key sections hold the location of these pieces within the source item.
m. KEYCHAIN: element. Holds decoding information for a specific source. It is a list of formulas for a specific sources' content.
n. LOG FILES: element. Actions taken by users are recorded in a file. Mobile devices and the PC application upload this file to the server during the content request session. The website updates the log file on the server automatically.
o. POLLING ELEMENT: function. The part that activates the filter algorithm.
p. REGISTRATION: function. Initializes the user database. Authenticates. the user by pairing the user ID to the device serial number and using other standard authentication procedures.
q. SERVER: Machine where all databases are kept along with iSource content, Delivery system and Filter Machine. Server may consist of multiple machines as in load sharing or performing specific tasks.
r. SOURCE(S): element. An external source of content. For example, www.cnn.com
s. SOURCE ITEM: element. The specific page on the sources' side that physically holds content.
t. USER ID: element. A unique number assigned to a user.
u. USER DATABASE: element. Holds personal information and profile information of the user along with passwords and serial # of devices.
v. USER PREFERENCES: The list of iSources the user wishes to subscribe to. This list is used by the delivery system in order to build a user specific package.
w. USER PROFILE: element. A set of user specific personal information and preferences stored in the user database.
x. WEB DISPLAY: Web based program that allows viewing and management of iSources on a user specific level.

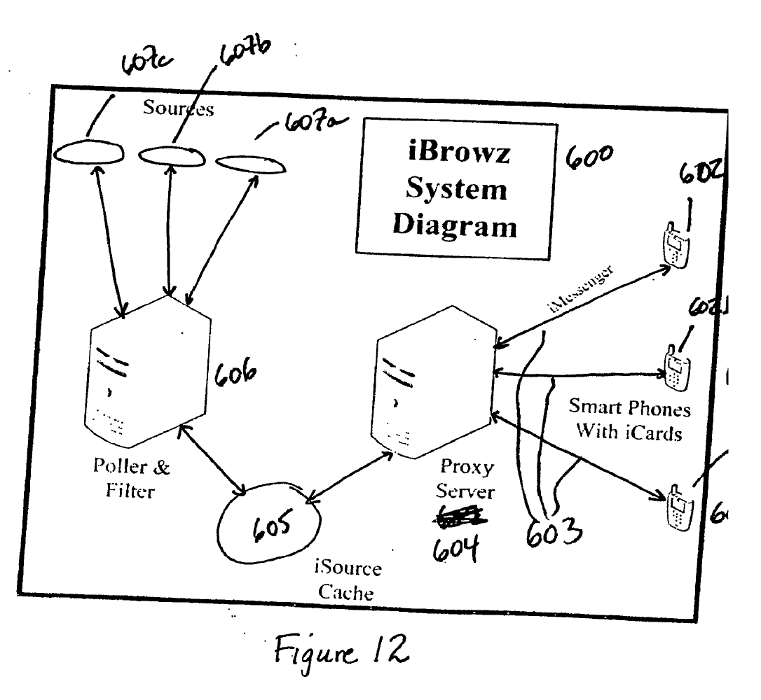

FIG. 12 describes the major components of a preferred embodiment of one aspect of the present invention relating to a handheld device with flash memory card. The system 600 includes handheld devices 601a-601c that are equipped with removable flash memory cards 602a-602c. In a particularly preferred embodiment, the handheld devices 601a-601c are smart phones capable of wireless Internet connectivity. In the context of describing this embodiment, wireless refers to the handheld device's data service from her ISP. Unless otherwise specified, wireless does not refer to Bluetooth capability or voice service. In a particularly preferred embodiment, the flash memory cards 602a-602c are San Disk (Milpitas, Calif.) Trusted Flash SD Cards. The handheld devices 601 are provided with Internet connectivity through communication links 603. The handheld devices 601 access a proxy server 604 operated by the iBrowz service provider (Intouch Group, Berkeley, Calif.). The proxy server 604 accesses a cache 605. This cache 605 is supplied with content from another server 606 that functions to poll and filter sources 607a-607c for content. The cache 605 contains web content that has been filtered and formatted for display on the handheld device 601.

The iBrowz web browser application (Intouch Group, Berkeley, Calif.) provides a web browser functionality to the handheld device 601 when provided with the flash memory card 602. The web browser will display content from any web site, but it is optimized to display content that has been pre-filtered and formatted by the poller/filter server 606 stored in the cache 605 and accessible through the proxy server 604. The web browser of the present invention (referred to as iBrowz web browser in a particularly preferred embodiment) is distinguished from other commercially available browsers because it possesses many features not found in currently available products. For example, the iBrowz web browser includes a registration process whereby the consumer/end user fills out a user profile and submits it to the iBrowz system operator either by synchronization with a host computer, or by submitting it to the system operator wirelessly from the handheld device 601. In this context, the host computer refers to the consumer's desktop computer or laptop computer. The iBrowz web browser can also operate in a synchronized mode (referring to the coordination of data maintained by the handheld device and the user's host computer), or in a wireless mode, according to user preferences. Another distinguishing feature is that the iBrowz web browser has a user set up process in which the consumer/user selects her preferred web sites from a list presented by the browser. In the wireless mode, the user also selects the polling frequency at which the handheld device will refresh selected content. This set up information is transmitted wirelessly to the system proxy server 604.

There are additional distinguishing features. The iBrowz web browser can surf the content stored on the flash memory card 602 and display this content on the handheld device 601 display screen. The content on the flash memory card 602 is hyperlinked to other content on the flash memory card. Therefore, browsing on the flash memory card 602 is substantially identical to browsing web sites on the Internet, although the response from the flash memory is essentially instantaneous. The iBrowz web browser also includes a wireless stealth polling operation in which the browser does not seize control of either the handheld device 601 display screen nor any of the controls of the handheld device. This stealth polling operation is set up by the user/consumer in the set up process, and is launched automatically from a timer tick. When initiated, the polling operation sends a packet to the proxy server 604 requesting updated content. The proxy server 604 in cooperation with the cache 605 returns whatever content has changed since the last poll, and the iBrowz web browser causes this updated content to be saved to the flash memory card 602. The iBrowz web browser also offers a different channel for updating. So, when the handheld device 601 is synchronized with a host computer (e.g., the user's desktop computer or laptop computer), the updated content can be obtained from the proxy server 604 through the connection of the host computer to the proxy server 604 and the connection of the handheld device 601 to the host computer. This updating allows the user to receive the same refreshed content as she would have obtained wirelessly through the direct connection of the handheld device 601 to the proxy server 604.

The common protocol for synchronizing the handheld device and the user's host computer involves the user connecting the handheld device to the user's host computer using a USB cable or a Bluetooth connection. It is necessary that the connection between the handheld device and the host computer allows data to travel in both directions. The purpose of this type of synchronization is to transfer data back and forth between the handheld device and the host computer until the relevant data on both devices is substantially identical.

The Handheld Device Operating the iBrowz Web Browser Application

In the following description of a particularly preferred embodiment, the handheld device 601 is a Palm Treo device with a five way navigation button. It will be appreciated that the purpose of being so specific is for purposes of illustration and it is not intended to be limiting in any way.

The features of the iBrowz web browser application enable certain desired capabilities: (1) browsing popular news/headline web sites; (2) browsing other popular on-line services like weather and movie locations and times; (3) browsing popular social networking sites such MySpace; (4) using the browser to obtain maps and directions; and, (5) browsing music sites such as www.worldwidemusic.com and others; (6) allowing the device owner to browse content, not necessarily available on web pages, which content owners have pushed onto the device, including ads, music, games, etc. The content is available for sampling, re-ordering, and purchase.

The iBrowz web browser is supplied to the user on the flash memory card 602. When the user inserts the flash memory card 602 into the handheld device 601, an installation dialog is presented and asks the user if she wants to install the iBrowz web browser application. If the user responds “yes,” the application gets installed and launched. With regard to the synchronization application for the user's host computer, this application is downloaded to the host computer from the Internet. The user receives directions on how to download the synchronization application in an e-mail sent following the user registration process for the handheld device described below.

If the user removes the flash memory card 602 from the handheld device 601, then the iBrowz web browser application is terminated and no longer available on that handheld device 601.

When the user first signs in to the iBrowz web browser application, the user is presented with a user registration screen. The user is asked for personal information which can also include demographic information. The user is also asked to respond to a series of questions designed to elicit that user's preferences, including music and games preferences for the push content. Finally, the user is asked to check off a series of web sites that are available through the iBrowz web browser services and to identify those web sites to which the user wishes to subscribe. The user also specifies how often she would like the content to be refreshed. The selections are then stored on the flash memory card 602 The user then passes this profile information to the iBrowz system proxy server 604 through the wireless services on the handheld device 601. The proxy server 604 accepts the registration information and in response sets a cookie on the handheld device 601.

One of the benefits of the user registration process is to accumulate data that can be used to market and sell additional goods and services to the user. When the user provides personal information, demographic information to makes selections of the web sites and services that interest her, the iBrowz system is provided with data that is useful in designing targeted marketing and advertising campaigns. Moreover, because the iBrowz system captures even logs from both the handheld device and the host computer, there is additional behavioral information that allows for data mining to provide targeted marketing and advertising campaigns.

As previously described above, there are many commercially available customer relations manage software products that can be used to capture user data and user activity and then match that date against potential advertisers and potential content providers to deliver customer-specific marketing and advertising. Some examples include, but are not limited to, Kana Software (Menlo Park, Calif.), Coremetrics, Inc. (San Mateo, Calif.) and Mercado Software (Pleastanton, Calif.).

In the preferred embodiment, user activity or event logs can be maintained and managed for the handheld device and for the host computer.

One of the most important processes for the commercial saleability of the flash memory card 602 is the delivery of fresh content to the user on the handheld device display. Just imagine how useless five day old stock quotations would be, or month old movie schedules, or for that matter, day old weather forecasts. Without fresh content, the iBrowz web browser quickly can become irrelevant. The iBrowz web browser and supporting service allow the user to subscribe to precisely the content in which he has interest. The user can also specify the frequency at which his subscribed content is refreshed. At the specified refresh frequencies, an automated aspect of the iBrowz web browser queries the iBrowz system proxy server 604 for new or changed content. When the proxy server delivers this data to the handheld device, it is stored on the flash memory card 602. On the iBrowz service side, the poller-filter server is continually going out to sources 607a, 607b and 607c and downloading content. This content is filtered and reformatted for display on the handheld device 601. The filtered and reformatted content is then stored on a cache 605. A separate process at the proxy server 604 receives requests from individual handheld devices 601. This proxy server 604 process extracts responsive data from the cache 605 and serves it back to the requesting handheld device 601.

This process for refreshing content occurs through a polling step. The overall intent of the polling process is for the iBrowz web browser to contact the iBrowz system proxy server to obtain fresh and timely content, as well as personalized content to be downloaded to the handheld device 601. The polling operation is set by the iBrowze web browser during the user registration process. Polling occurs at specified time intervals that are set and designed to keep the content maintained within the iBrowz web browser current.

All web pages that have been filtered and reformatted by the poller-filter server 606 are given unique and monotonically increasing identification numbers by the methods that create the web pages. When a content page changes at the source 607 over time, the changed content gets a new identification number.

There are two generalized types of handheld devices, multi-tasking such as those operating Windows Mobile, and single tasking such as those operating using the Palm operating system. Since the polling operation is different in each of these environments, the polling operation is described for each environment of handheld devices.

In the multi-tasking operating system environment, the polling operation on the handheld device 601 runs on a thread attached to the handheld device operating system timer. There is no need for cooperation with other applications or operations on the handheld device as the thread executes till complete, and then it dies.

In the single tasking operating system environment, the polling operation runs somewhat differently. In these devices, it may be necessary to run the polling operation in the foreground in stealth mode, with no input or output devices attached. The only visible clue that the polling operation is occurring will be that the network connect indicator (on Treos for example, an orange LED) is lit. It is also requires cooperative behavior with other operations and applications being performed on the handheld device 601. So, for example, if the user manually launches another application during the polling operation, or if there is an incoming call, the polling operation will terminate quickly, but without corrupting any data.

A key component of the polling operation is the cookie that is set on the handheld device 601 by the iBrowze system proxy server 604. If the proxy server 604 determines that no cookie is present on the handheld device 601, then the polling operation aborts immediately. If the cookie is present, then the iBrowze web browser passes that cookie to the proxy server 604 along with a request to refresh. The iBrowze web browser sets a timeout and waits for a response from the proxy server 604. If the timeout occurs before the requested information arrives, the iBrowz web browser logs an error condition, closes the network connection and exits the polling operation. If the requested information packets arrive before the timeout, then the new content is stored on the flash memory card 602, the iBrowz web browser logs the event, closes the network connection and exits the polling operation. The polling operation uploads the activity or event log to the proxy server 604 on a set schedule during polling.

On the iBrowz service side, the poller-filter server 606 keeps a schedule of all of the sources 607a-c that it must poll and the frequency at which it must poll them. Some sources 607 change by the minute like stock quotations. The user expects that the ibrowz system will keep track of and deliver these changes instantaneously. Other sources, e.g., movie listings, change only once weekly. The poller-filter server 606 keeps a database describing the various sources 607. There is a field with the source 607 web address. There is a field giving the source 607 data class. Each data class has associated filtering methods to reformat content for display on the handheld device 601. After extracting the raw data stream from the source 607, the poller-filter server 606 builds new web pages for display using the iBrowz web browser and the handheld device 601. If the new page is the same as the old cached page, (detected by checksum), the new page is discarded. If the new page is different from the already-cached page, the filter process caches the new page.

Some content may have to be personalized for the user. For example, the user may require weather or traffic information that is based upon her location. Personalized content of this nature is requested by the handheld device 601 using personalization parameters (e.g., zip code) supplied by the handheld device 601. When the request is received at the proxy server 604, the request is passed through to the poller-filter server 606 where the personalization parameters are included in the hftp requests to the sources 607. Just like non-personalized content, the poller-filter server 606 determines whether the filtered content is identical to the stored content (cache 605.) If yes, the new content is discarded. If no, the new page is cached 605. The cached content is then packaged and sent to the requesting handheld device 601.

The iBrowz system employs an application called iMessenger to be responsible for content synchronization between the handheld device 601 and the proxy server 604. iMessenger runs on a background thread on the handheld device 601. The iMessenger application is launched by the handheld device 601 timer. iMessenger makes a list of only the sources 607 whose scheduled polling time has arrived. For each timely source 607, iMessenger then makes a tree-structured list of all content file names on the handheld device 601 flash memory card 602. iMessenger transmits this list of source tree file names to the proxy server 604. The proxy server 604 takes the list and compares file identifications to the contents of its cache 605. The proxy server 604 transmits back to the handheld device 601 the new list of file identifications for each source 607. Because the file names are sorted in descending order by file identification number, iMessenger may, if it wishes, stop the list download as soon as it encounters a file identification number less than any one file identification number on its current list. This process can save some download time. iMessenger the takes over the operation. iMessenger caches the new file list. For files whose names are no longer on the list, iMessenger deletes the files from the flash memory card 602. For files that were and still are on the list, iMessenger takes no action. For a new file that does not appear on the flash memory card 602, iMessenger sends out a request to the proxy server 604 to download the file, which it then caches on the flash memory card 602. These file download requests are treated in the ordinary way by the proxy server 604.

When the process involves refreshing personalized content, iMessenger sends the personalization parameters along with the file lists. The rest occurs as with non-personalized content.

The proxy server 604 also chooses among pushed content items in its inventory to download to the handheld device 601. The choice is informed by information collected by the iBrowz application and processes by data mining services as described above. The pushed items include ads targeted to the customer's browsing patterns, music targeted to the customer's preferences and the like.

The proxy server 604 compresses some content before shipping it to the handheld device 601. Compression allows content to be shipped. much more efficiently than if ordinary http transmission were used. The compressed content is decompressed by iMessenger before being cached to the flash memory card 602.

The iBrowz web browser browsing operations on the handheld device 601 are launched manually by the user. When launched, the iBrowz web browser checks whether a cookie has been set on the handheld device 601 by the iBrowz system proxy server 604. If no cookie is set, then the browser launches the user registration process described above. If a cookie is present, then the iBrowz web browser goes to the home page for normal off-line browsing. During browsing, all user actions (keystrokes, hyperlinks, etc.) are recorded in a user log on the flash memory card 602. This log is routinely uploaded to the proxy server and is cleared upon upload or synchronization with the user's host computer. This is one of the logs that is used to accumulate user activity data that can be used to target market and target sell additional goods and services to the user.

Normally, the user will be using the iBrowz web browser in an off-line mode—the user will be browsing the content stored on the flash memory card 602, and will not be on-line obtaining content from online sites. The iBrowz web browser home page is stored on the flash memory card 602. The home page is an index into all of the content as selected by the user at registration time, or as modified at any time using the options tool. The web browser display scrolls vertically. The order of the items displayed is set by the iBrowze system operator, according to rules set up with individual web site owners. The display provides space for links to paid advertising on the top hand of the each page. However, these links are to preloaded content stored on the flash memory card 602, and require no initiative from the browser to connect and download this data from external sites on the fly as the content is being displayed. When the user selects a hyperlinked item on the display screen, the iBrowz web browser loads the linked page onto the display screen, replacing the previously viewed display screen. Forward and back controls are provided as part of the graphical user interface and operate as one would expect them to operate as part of a web browser application.

The user can also use the iBrowz web browser to manually request URLs that are not part of the user's normal subscriptions. The user can manually enter the URL into the browser address bar and select the “Go” function. Alternatively, in certain cases, the user can open the “Favorites” list and click on the URL presented in the Favorites List of URLs. In this event, the URL must have previously been added to the Favorites List. In the instance of web pages that have not been subject to pre-filtering and pre-formatting using the system polling-filtering server, the web pages are not pre-filtered and their appearance on the handheld device 601 display screen may be difficult to interpret. If the user hits a hyperlink that does not resolve to content stored on the flash memory card 602, or if the user manually enters a URL on the Internet and not on the proxy server 604, then the user is going on-line to browse. While the iBrowz web browser will attempt to fulfill the request made by the user, the results cannot be guaranteed to be delivered in a viewable format.

The iBrowz web browser application provides a user interface that relies partially on icons displayed on the display screen of the handheld device 601, and partially on pre-assigned function keys that are mechanically part of the handheld device. Upon clicking upon the iBrowz icon, the screen presents a drop down list of the following options: (1) Favorites; (2) Refresh All; (3) Refresh Screen; (4) Options—change Profile or Selections; (5) Stop current load; (6) Disconnect from network; and, (7) Exit application. The Favorites List contains both Selected Content and User-entered Content. This List can be edited using the Favorites Editing screen.

The Options selection drops down to a list of (1) Change Profile; (2) Change Selections; (3) Select/De-Select Wireless Operation; (4) Change Polling Frequency; (5) Opt in or out of advertising.

A Signal Power bar will be present on the user interface to show the strength of the signal from the local cell. The UI also has an Address Bar that can be launched to edit an address in the screen. The “Go” button loads the requested URLs.

On the TREO, the 5-way navigation button can be used to navigate hyperlinks, act on check boxes, radio buttons, drop down boxes and submit buttons. While the presently preferred embodiment has been described with reference to the TREO, it will be apparent that other apparatus and hardware may be substituted.

Another mode of system operation involves the synchronization of the handheld device 601 with the user's host computer. This is a feature that is ordinarily provided by the handheld device 601 vendor, without regard to the use or deployment of the present invention. The synchronization between the handheld device 601 and the host computer can be accomplished by either cable, Bluetooth or other channels provided by the vendor. With regard to the iBrowz applications, what gets synchronized are all the iBrowz data files stored on the flash memory card 602. Additionally, the transaction (event or activity) log (also stored on the flash memory card 602) gets copied to the host computer and the log is cleared on the handheld device 601. The GUI of the handheld device 601 posts an appropriate display screen when the handheld device 601 is being synchronized to the host computer.

On the host computer side, the host computer is responsible for making a shadow copy of the iBrowz flash memory card 602 content on the host computer. The host computer uploads all content from the device 601 and card 602 to the host computer. The host computer also sends a request packet to the proxy server 604 asking for current content. The host computer then receives the content from the proxy server 604, including embedded advertisements. The host computer reconciles the differences between old and new content using the same algorithms that the poller uses. The host computer then deletes all content on the handheld device 601 and card 602 and copies the reconciled content from the host computer to the handheld device 601 on through to the flash memory card 602. As part of the Synchronization Operation, the host computer uploads the transaction log to the proxy server 604 and clears the transaction log on the flash memory card 602.

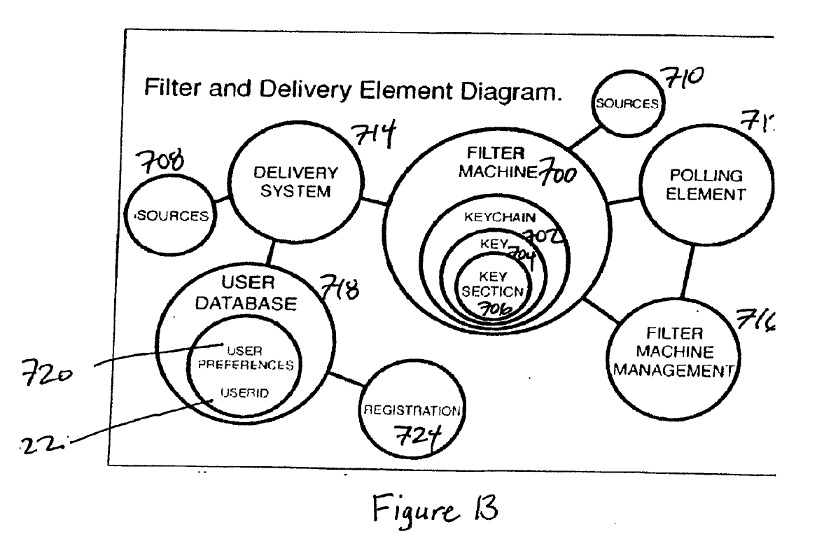

A more detailed description of the operation of the poller-filter server 606 is described with reference to FIG. 13, using the terms set forth in the Glossary above. In the following section, the use of all upper case letters to spell a word signifies a link to the Glossary. The FILTER MACHINE 700 provides for storage of decoding information. Each source 710 is assigned to a KEYCHAIN 702 that holds a set of KEYS 704. Each KEY 704 has a set of KEY SECTIONS 706 used to DECODE the sources' SOURCE ITEMS. A single source may have many KEYS 704 on its KEYCHAIN 702, or only one KEY 704, depending on the number of different FORMATS in which the source's content is delivered. KEYS 704 may have many or few KEY selections depending upon the level of FORMAT CONVOLUTION in the specific item.

KEYCHAINS 702 are stored on the poller-filter server 606 for later access by the FILTER ALGORITHM. The FILTER ALGORITHM uses KEYCHAIN information to find, decode and store all of the sources' (710) content as iSOURCES 708 for viewing by the WEB DISPLAY. As the FILTER ALGORITHM runs, it compares SOURCE ITEMS to existing content from which it has already been reformatted and stored in iSOURCE 708 format. If that particular item already exists, the FILTER ALGORITHM skips that item in order to be more efficient.

POLLING ELEMENT 712 activates the FILTER ALGORITHM. The frequency of FILTER ALGORITHM activation is set separately for each source and stored along with the rest of the KEYCHAIN 702 elements.

The system provides maintenance and management of the sources and formats through the Filter Machine Management 716. Errors in these areas will be reported by the FILTER ALGORITHM as it runs. Any changes to the FILTER MACHINE and any of its editable elements are made through a management program that allows for the addition and removal of sources 710, changes to the KEYCHAIN 702 and its elements, changes to the POLLING FREQUENCY, and the improvement of the functioning of any element in the system.

Still with reference to FIG. 13, the DELIVERY SYSTEM 714 fulfills requests at a user specific level. The DELIVERY SYSTEM is activated by the request of a DEVICE, and authenticates the user against the registration information. The DELIVERY SYSTEM compares the CURRENT CONTENT SYSTEM and packages new content. The DELIVERY SYSTEM is involved in updating the CURRENT CONTENT SYSTEM and delivers new content.

The system employs a USER DATABASE 718 that contains information about system users and their handheld devices 601. The USER DATABASE pairs the serial numbers of the handheld devices 601 with the user_id 722 contained in the USER DATABASE. The registration process can be activated by user request.

The system also presents an iBrowz web site. This web site allows subscribers to access iSOURCES 708 using a standard (non-iBrowz) web browser. The web site also enables the user to update, change or modify profile and preference information. This web site uses USER PREFERENCES 720 to display user-specific iSOURCES 708.

User actions on the web site are tracked in LOG FILES. This data from the LOG FILES provides an alternative platform for targeted advertising delivery. The iBrowz web site also provides a place for users to download applications such as the host computer synchronization application.

It is contemplated that the system will necessarily support HTTP 1.1, WML 1.3, GIF, animated GIF, JPEG, PNG and cookies. Optionally, the system may support HTML 4.01, SSL 3.0, 128-bit SSL encryption, CSS 1.0 and 2.0 and BMP.

While the present invention has been described with reference to specific embodiments, which are intended to illustrate and not to limit, those of ordinary skill in the art will recognize that certain changes and modifications may be made to the above-described embodiments without departing from the spirit of the invention and scope of the appended claims.

I claim:

1. A portable digital media playback apparatus having a large number of preloaded digital media files for preview by a user, the apparatus comprising:
(A) an operating system for operating the portable digital media playback apparatus, the operating system comprising executable software code for
(1) tagging at least one preloaded digital media file with information that identifies that file as a file for purchase or rental by the user;
(2) communicating the information concerning the tagged file to a computer separate from the portable digital media playback apparatus; and
(3) deleting digital media files from the portable digital media playback apparatus when a delete command is received from the separate computer for a particular digital media file;
(B) a communication port allowing the portable digital media playback apparatus to communicate with the separate computer;
(C) a data storage device preloaded at the time of purchase with at least about 128 KB of digital media files for preview by the user, the digital media files having limited usage rights; and,
(D) a user interface associated with the portable digital media playback apparatus operating system to direct the operating system to tag one or more digital media files with information that identifies that file as a file for purchase or rental by the user.

2. The apparatus according to claim 1, wherein the preloaded digital media files comprise at least about 75% of the storage capacity of the portable digital media playback apparatus data storage device.

3. The apparatus according to claim 2, wherein the preloaded digital media files comprise at least about 50% of the storage capacity of the portable digital media playback apparatus data storage device.

4. The apparatus according to claim 3, wherein the preloaded digital media files comprise at least about 25% of the storage capacity of the portable digital media playback apparatus data storage device.

5. The apparatus according to claim 1, further comprising,
a user interface allowing the user to rate the digital medial file; and
a ratings file associated with the portable digital media playback apparatus operating system for storing the ratings information for a particular digital media file.

6. The apparatus according to claim 5, wherein the operating system provides a rating system having a numerical value from 1 to 5.

7. The apparatus according to claim 1, wherein the portable digital media playback apparatus operating system includes digital rights management instructions that manage the usage rights of the preloaded digital media files and deletes untagged preloaded digital media files according to the corresponding usage right of that preloaded digital media file.

8. A method for providing and managing large numbers of digital media files on a portable digital media playback apparatus for preview and purchase or rental by a user, for use in conjunction with a computer separate from the potable digital media playback apparatus, the method comprising:
(A) providing a portable digital media playback apparatus having
an operating system including executable code (1) for tagging at least one of the digital media files with information that identifies that file as a file for purchase or rental; (2) communicating information concerning the tagged file to the computer separate from the portable digital media playback apparatus; and (3) for deleting digital media files from the portable digital media player apparatus when a delete command is received from the separate computer directed to a particular digital media file,
a communication port allowing the portable digital media playback apparatus to communicate with the separate computer, and,
a data storage device;
(B) providing on the portable digital media player apparatus storage device at the time of purchase at least about 128 KB of digital media files for preview by the user, the files having limited usage rights;
(C) providing a user interface associated with the portable digital media playback apparatus operating system to tag one or more digital media files with information that identifies that file as a file for purchase or rental by the user; and,
(D) in response to the information that identifies that file as a file for purchase or rental, providing on the portable digital media playback device a digital media file that possesses the appropriate digital rights corresponding to the tagged file information.

9. The method of claim 8 further comprising the step of deleting untagged digital media files from the storage device of the portable digital media playback apparatus in response to a delete command issued by the separate computer.

10. The method of claim 9 further comprising the step of transmitting from the separate computer and storing in the storage device of the portable digital media playback apparatus new digital media files for preview by the user.

11. The method according to claim 8, wherein the preloaded digital media files comprise at least about 75% of the storage capacity of the portable digital media playback apparatus data storage device.

12. The method according to claim 8, wherein the preloaded digital media files comprise at least about 50% of the storage capacity of the portable digital media playback apparatus data storage device.

13. The method according to claim 8, wherein the preloaded digital media files comprise at least about 25% of the storage capacity of the portable digital media playback apparatus data storage device.

14. The method according to claim 8 further comprising the step of rating the preloaded digital media file after preview by the user,
wherein the portable digital media playback apparatus further includes a user interface that enables the user to rate the preloaded digital medial file, and includes a ratings file associated with the portable digital media playback apparatus operating system for storing the ratings information for a particular preloaded digital media file.

15. The method according to claim 14 further comprising the steps of
(1) transferring ratings information from the portable digital media playback apparatus ratings file to the separate computer; and
(2) using the separate computer, sending the ratings file to a web site.

16. The method according to claim 14 wherein a numerical value from 1 to 5 is provided for the rating step.

17. A portable digital media playback apparatus preloaded with a large number of digital media files at the time of purchase comprising:
storage media for storing preloaded digital media files for preview by a user;
a large number of preloaded digital media files stored in said storage media and available for preview by the user;
first executable software code for deleting at least one preloaded digital media file from the portable digital media playback apparatus storage media when a delete command is received;
second executable software code for tagging at least one preloaded digital media file with information that identifies the file as a file for purchase or rental by the user;
a first user interface allowing the user to issue delete commands to the first executable software code to delete preloaded digital media files from said storage media
a second user interface allowing the user, through operation of the second executable software code, to tag at least one preloaded digital media file with information that identifies that file as a file for purchase or rental by the user
a communications port between the portable digital media playback apparatus and the separate computer; and,
third executable software code for allowing the portable digital media playback apparatus to issue a request to the separate computer for the appropriate digital rights for the at least one digital media file corresponding to the information that identified the file as a file for purchase or rental.

18. In a system comprising a portable digital media playback apparatus loaded with a large number of digital media files for preview by a user of the portable digital media playback apparatus, a separate computer and a content provider server, a method for delivering recommended digital media files for preview on the portable digital media playback apparatus, the method comprising:
(a) on the portable digital media playback apparatus, creating a user profile based upon user interactions with the digital media files for preview loaded on the portable digital media playback apparatus;
(b) transmitting the user profile from the portable digital media playback apparatus to the separate computer through a communications port on the portable digital media playback apparatus;
(c) transmitting the user profile from the separate computer to the content provider server;
(d) at said content-provider server, comparing characteristics of digital media files available for preview with the user profile;
(e) transmitting from the content provider server to the separate computer a plurality of digital media files, with limited usage rights, for preview that match at least one aspect of the user profile; and,
(f) transmitting from the separate computer the plurality of plurality of digital media files, with limited usage rights, for preview that match at least one aspect of the user profile to the portable digital media playback apparatus.

19. The method according to claim 18 wherein the user profile also contains demographic information about the user.

20. The method according to claim 18 wherein the user profile contains rating information entered by the user comprising the user's rating of the digital media files that the user has already previewed.

21. Removable flash memory card having digital data storage capacity in excess of 256M preloaded with computer-executable instructions and digital media prior to the time of retail sale to a consumer user;
the computer-executable instructions comprising a web browser application that accesses the operating system of a handheld portable device into which the card has been installed, that browses the preloaded digital content on the card and that displays the preloaded digital content on the card to a display on the handheld portable device in a format specifically adapted for the handheld device; and
the preloaded digital media comprising digital content from digital content providers, the preloaded digital media having already been pre-filtered and pre-formatted for use with the web browser application also preloaded on the card to allow for the display of the preloaded digital media on the display of the handheld portable device in a format especially adapted for the handheld device.

22. The removable flash memory card of claim 21 further comprising preloaded computer-executable instructions that generate a graphical user interface querying the consumer user for personal profile information that when entered by the user is stored on the flash memory card as a user profile file.

23. The removable flash memory card of claim 21 further comprising preloaded computer-executable instructions that generate a graphical user interface querying the consumer user about which preloaded digital media the user wants to maintain and to update on the card.

24. The removable flash memory card of claim 21 in combination with a handheld portable smartphone having a slot for loading and removing the removable flash memory card, an operating system, and an Internet-protocol communication port for establishing an Internet connection from the smartphone.

25. A system for refreshing digital media stored on a removable flash memory card installed in a handheld portable smartphone, the system comprising:
a handheld portable smartphone with an operating system and an Internet-protocol communication port in combination with a removable flash memory card having digital data storage capacity in excess of 256M, preloaded with computer-executable instructions and with digital media, the computer-executable instructions (i) generating a graphical user interface querying the consumer user about the preloaded digital media the user wants to maintain and update on the flash memory card; (ii) storing the user's responses to the queries as part of a user profile file; and (iii) an application for content synchronization between the handheld portable smartphone and a proxy server; and,
the proxy server in communication with the handheld portable smartphone through the Internet-protocol communications port to receive a list of the files on the removable flash memory card and to compare the smartphone file list with the file list for a cache memory accessed by the proxy server to determine differences between the lists and to download the new files on its list that do not exist on the removable flash memory card list of files.
